(19) United States
(12) Patent Application Publication
(10) Pub. No.: US 2012/0180445 A1
(43) Pub. Date: Jul. 19, 2012

(54) LAWN EDGER

(76) Inventor: Edward Duller, Clearwater, FL (US)

(21) Appl. No.: 13/349,109

(22) Filed: Jan. 12, 2012

Related U.S. Application Data
(60) Provisional application No. 61/432,887, filed on Jan. 14, 2011.

(51) Int. Cl. A01D 34/00

(52) U.S. Cl. 56/12.7

(57) ABSTRACT

A lawn edger includes a support shaft having an upper end and a lower end. An arm support surface is supported on the support shaft and a cutting blade is operably coupled to the lower end of the support shaft. An engine is supported on the support shaft between the upper end and the lower end and is operably coupled to the cutting blade. The lawn edger further includes a control grip supported on the support shaft between the arm support surface and the engine. The control grip is operably coupled to the engine and includes a user input to control operation of the engine.

### CROSS-REFERENCE TO RELATED APPLICATION

This application claims priority to U.S. Provisional Patent Application Ser. No. 61/432,887, filed Jan. 14, 2011, the disclosure of which is expressly incorporated by reference herein.

### BACKGROUND AND SUMMARY OF THE INVENTION

The present invention relates generally to powered tools and, more particularly, to a lawn edger having an arm support with improved ergonomic characteristics.

Powered tools are often used for lawn care and gardening applications. For example, lawn edgers are typically used to provide a clean border when a grass surface abuts a non-grass surface, such as a garden, tree bed, walkway, or driveway. Conventional powered lawn edgers may include a cutting blade and an engine supported at opposing ends of a rod or shaft. With such a design, the engine is positioned near the forearm of the operator, thereby making it necessary for the operator to hold the edger along the shaft at a position forward of the engine. A control device, or operator interface, may be positioned forward of the engine along the shaft to allow the operator to control the speed of the cutting blade. An auxiliary handle may be provided on the shaft of the edger to assist the operator in controlling the position of the cutting blade during edging. In use, the cutting blade of the edger is positioned against the ground and rotates as the lawn edger is moved along the border of the grass surface. Lawn edgers may have a support wheel positioned near the cutting blade to further assist the operator in guiding the cutting blade during edging.

According to an illustrative embodiment of the present disclosure, a lawn edger includes a support shaft with an upper end and a lower end. An arm support surface is supported on the support shaft and a cutting blade is operably coupled to the lower end of the support shaft. An engine is supported on the support shaft between the upper end and the lower end and is operably coupled to the cutting blade. The lawn edger further includes a control grip supported on the support shaft between the arm support surface and the engine. The control grip is operably coupled to the engine and includes a user input to control operation of the engine.

According to another aspect of the present disclosure, a powered lawn tool includes a support shaft having an upper end and a lower end. A driven member is operably coupled to the lower end of the support shaft, and an engine is operably coupled to the driven member and is supported on the support shaft between the upper end and the lower end. A control grip is supported on the support shaft intermediate the upper end of the support shaft and the engine. The control grip is operably coupled to the engine and includes a user input to control operation of the engine. A guide handle is supported on the support shaft and is positioned intermediate the control grip and the driven member.

According to a further illustrative embodiment of the present disclosure, a lawn edging device includes a support shaft having an upper end and an opposing lower end. The lawn edging device also includes an adjustable arm support operably coupled to the upper end of the support shaft, and configured for pivotal and axial movement. The lawn edging device further including a cutting blade operably coupled to the lower end of the support shaft. A guide wheel is coupled to the lower end of the support shaft proximate the cutting blade. Additionally, the lawn edging device includes an engine operably coupled to the cutting blade to drive the cutting blade in rotation and supported on the support shaft between the cutting blade and the arm support. The lawn edging device further includes an adjustable control grip supported on the support shaft intermediate the arm support and the engine. The control grip is configured for at least axial movement along the support shaft. The control grip also is operably coupled to the engine and includes a user input to control operation of the engine. The lawn edging device also includes a guide handle supported on the support shaft and positioned intermediate the engine and the cutting blade.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view of an illustrative lawn edger of the present disclosure, showing an arm support in a raised position;

FIG. 2 is an exploded perspective view of the lawn edger of FIG. 1;

FIG. 3 is a perspective view of an upper end of the lawn edger, showing an adjustment member coupled to a support shaft and the arm support;

FIG. 4 is a perspective view similar to FIG. 3, showing the arm support in an axially extended position;

FIG. 5 is a perspective view of an upper end of the lawn edger of FIG. 1, showing the arm support in the raised position and a control grip axially positioned forward of the arm support;

FIG. 6 is a further side perspective view of the upper end of the lawn edger of FIG. 5, showing the arm support in a lowered position and the control grip axially positioned forward of the arm support;

FIG. 7 is a perspective view of a lower end of the lawn edger, showing a guide wheel and cutting blade assembly;

FIG. 8 is a perspective view of a middle portion of the lawn edger, showing a guide handle and an engine;

FIG. 9 is a perspective view of the control grip, showing a clamp to couple the control grip on the support shaft; and

FIG. 10 is a rear perspective of the lawn edger, showing the control grip rotated about the support shaft to reveal a coupler between the support shaft and the engine.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

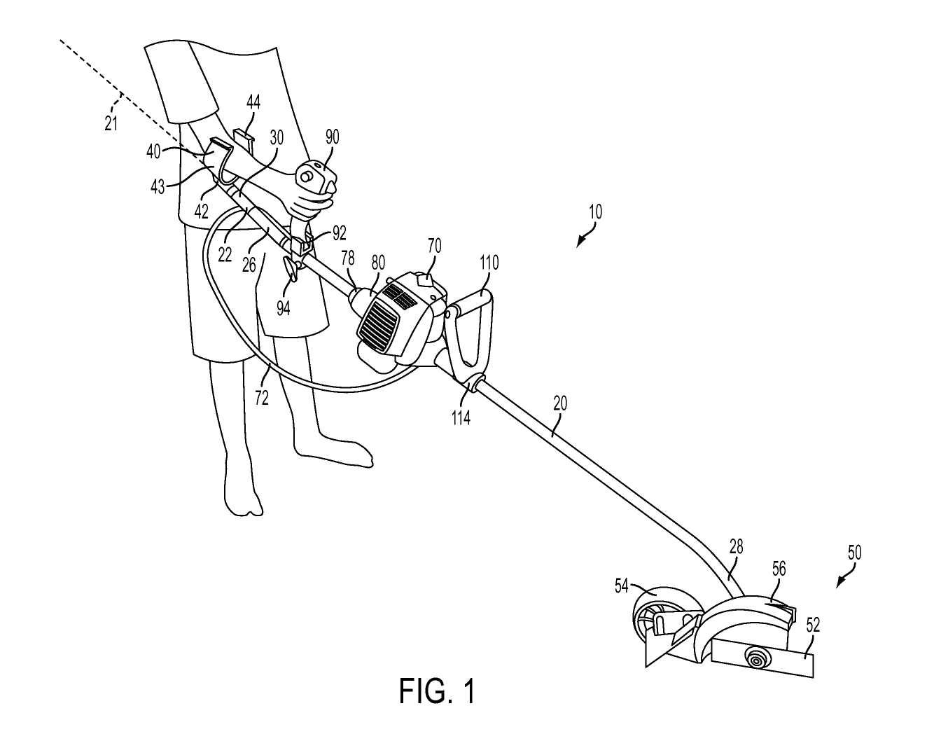

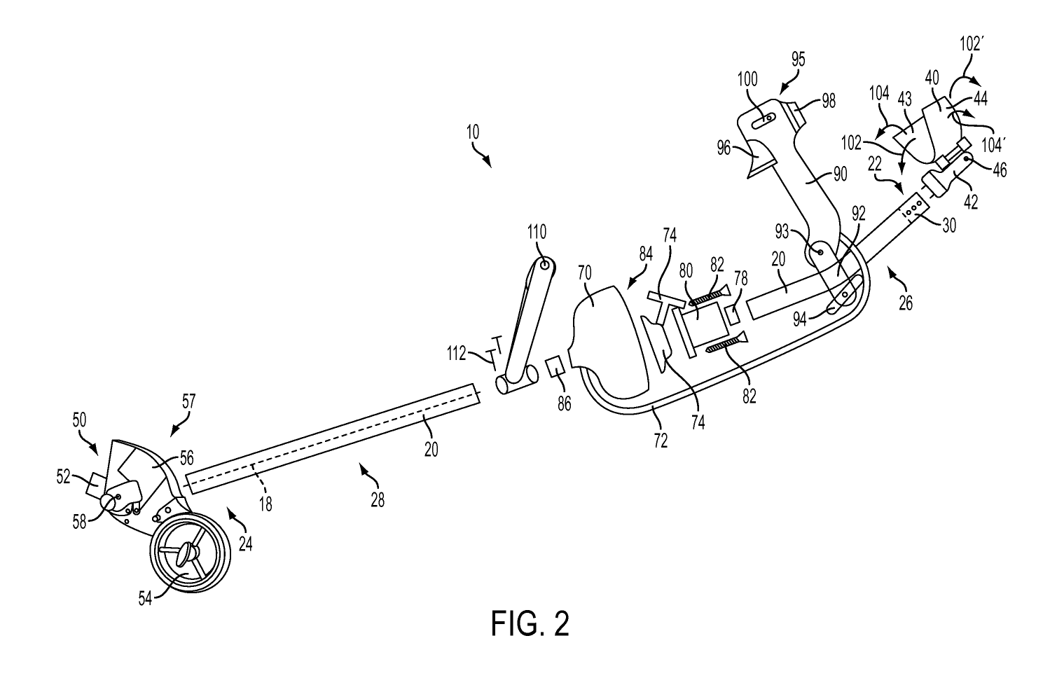

Referring initially to FIGS. 1 and 2, a powered lawn tool, illustratively a lawn edging device or edger 10, includes a support shaft 20 having an upper end 22 and an opposing lower end 24. Shaft 20 supports an arm support surface, illustratively defined by an arm support 40, at upper end 22 and a driven member 50 at lower end 24. Support shaft 20 further supports an engine 70 at a middle portion between upper end 22 and lower end 24. Engine 70 is operably coupled with driven member 50, illustratively a cutting blade 52. More particularly, engine 70 rotates cutting blade 52 during operation of lawn edger 10. Lawn edger 10 further includes a control grip 90 coupled to support shaft 20 intermediate arm support 40 and engine 70. Control grip 90 is operably coupled to engine 70 and includes a user input 95 to control the operation of engine 70. Illustratively, a guide handle 110 is coupled to support shaft 20 intermediate control grip 90 and driven member 50 to assist the operator when turning or maneuvering lawn edger 10.

In operation, support shaft 20 extends from upper end 22 forward of the operator in a downward direction toward lower end 24. As such, during normal operation upper end 22 of support shaft 20 is positioned near the operator's arm, while lower end 24 of support shaft 20 is positioned near the ground. Support shaft 20 includes an upper portion 26 aligned with a lower portion 28 along a longitudinal axis 21 of support shaft 20. Upper portion 26 extends between arm support 40 and engine 70, while lower portion 28 extends between engine 70 and driven member 50. By aligning upper portion 26 and lower portion 28 along longitudinal axis 21, the weight of lawn edger 10 is more evenly distributed along support shaft 20. As such, support shaft 20 does not tend to pull, or swing, the operator's arm when using lawn edger 10.

Support shaft 20 may be comprised of a rigid, durable material, such as metal or rigid plastic. Additionally, at least lower portion 28 of support shaft 20 is hollow to accommodate a drive shaft 18 extending between engine 70 and driven member 50. Lower portion 28 acts as a conduit for drive shaft 18 to operably couple engine 70 to driven member 50. As further detailed herein, upper portion 26 of support shaft 20 may be hollow or solid.

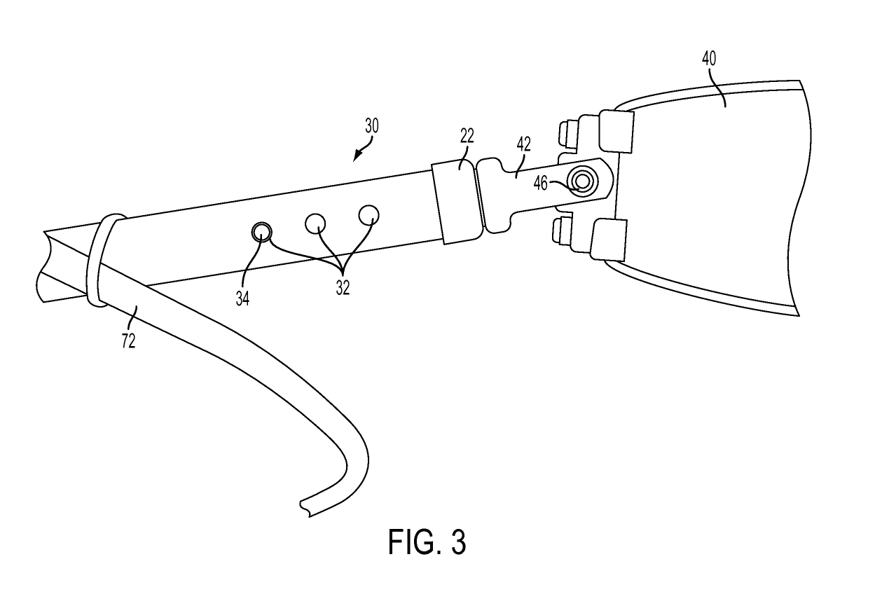

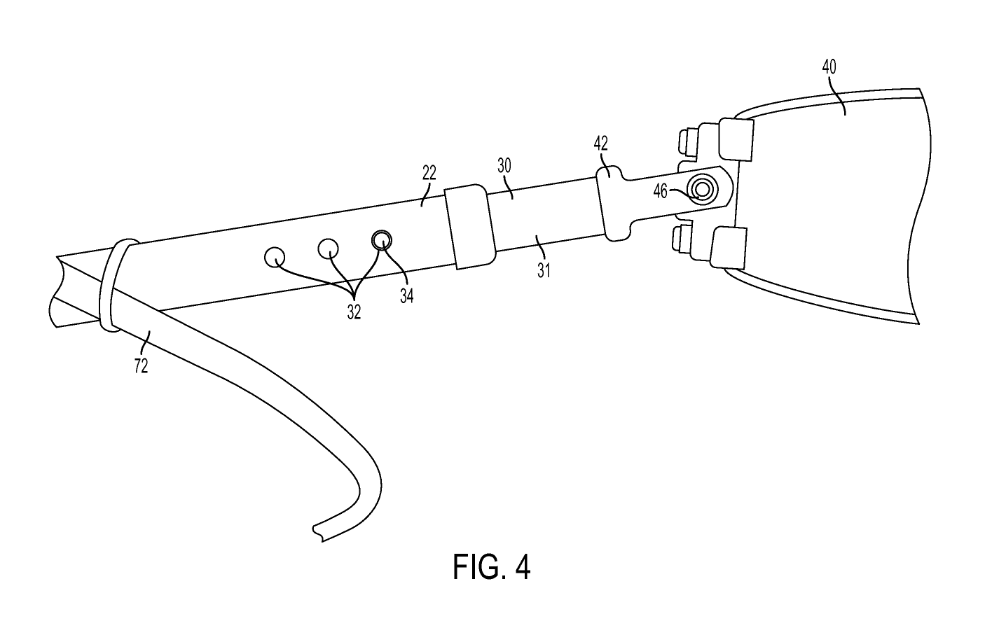

Referring to FIGS. 2-4, the length of support shaft 20 may be adjustable using an axial adjustment member 30 to accommodate the body dimensions and personal preferences of different operators. In one embodiment, support shaft 20 has a fixed length extending between upper end 22 and lower end 24. However, in an alternative embodiment, support shaft 20 may be lengthened/shortened by adjustment member 30. Illustratively, adjustment member 30 is coupled to upper end 22 of support shaft 20 and arm support 40. Adjustment member 30 includes a telescoping inner tube 31 received within hollow upper portion 26 of support shaft 20.

Adjustment member 30 is secured in a specific configuration by cooperation between a plurality of openings 32 and a detent pin 34. Pin 34 is illustratively coupled to inner tube 31 and spring biased outwardly for cooperating with openings 32 to temporarily lock, or secure, adjustment member 30 and, therefore, inner tube 31 at a particular length relative to support shaft 20. As such, when pin 34 is aligned with one of the openings 32, pin 34 extends outwardly within the selected opening 32, thereby preventing pin 34 from sliding along adjustment member 30. In other embodiments, adjustment member 30 may be any adjustable extension of support shaft 20. For example, adjustment member 30 may be threadably coupled to support shaft 20 and twist, or rotate, about support shaft 20 to adjust the relative position of tube 31. Conventional fasteners, such as screws, bolts, adhesive, welding, or rivets, may be used to couple adjustment member 30 to support shaft 20 and arm support 40.

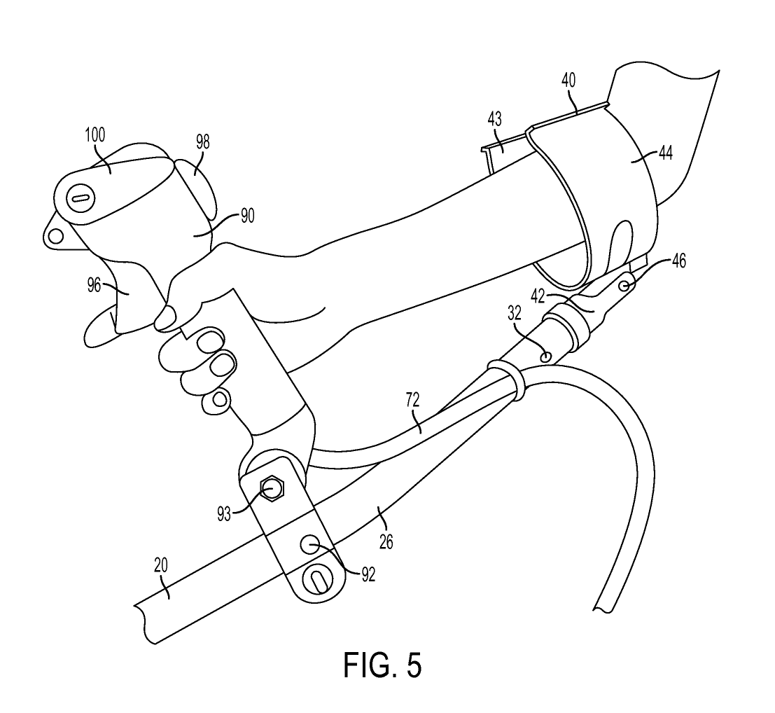

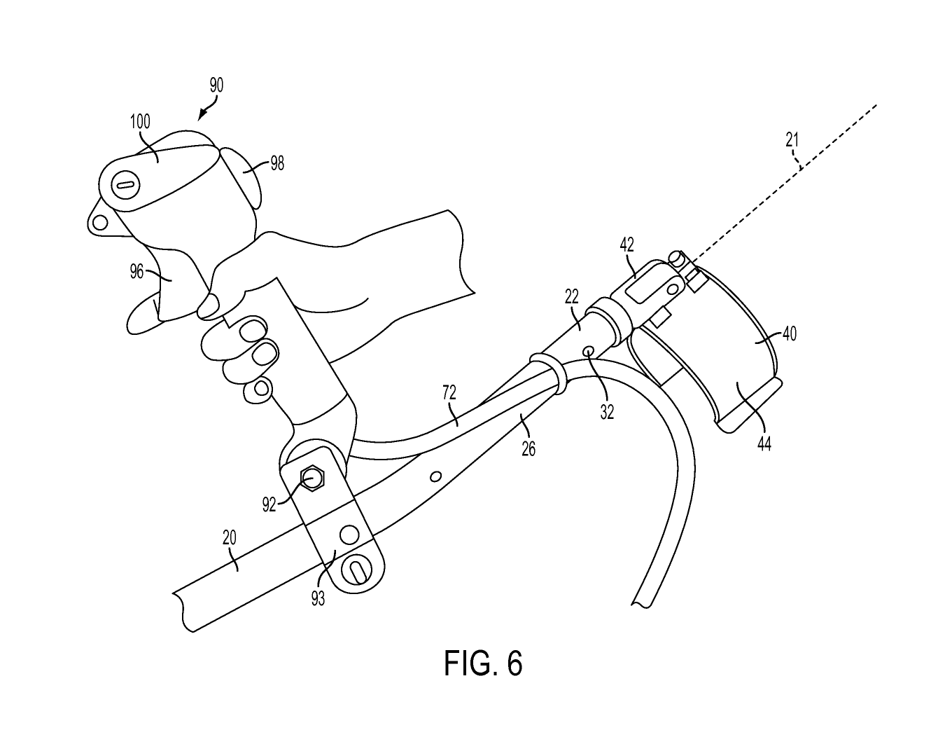

As shown in FIG. 2, illustrative arm support 40 is configured to rotate or pivot in order to adjust the position of arm support 40 relative to support shaft 20, control grip 90, and handle 110. More particularly, the operator may adjust the position of arm support 40 for more comfort or to move arm support 40 to a non-use position (not shown) when not needed. Referring now to FIGS. 2, 5, and 6, arm support 40 may be pivotably moved or rotated about an axis (not shown) transverse to longitudinal axis 21 (FIG. 6) such that arm support 40 moves in directions 102 and 102′ between a raised position (FIG. 5) and a lowered position (FIG. 6), respectively. For example, when arm support 40 is in the raised position, the operator's arm may be positioned within arm support 40 and supported above support shaft 20. When arm support 40 is in the lowered position, the operator's arm may be positioned within arm support 40 and supported below support shaft 20. Alternatively, arm support 40 may rotate about longitudinal axis 21 (FIG. 6) in directions 104 and 104′ for side-to-side movement. In particular, the arm support 40 may be rotated in directions 102, 102′, 104, or 104′ in order to provide comfort when the operator's arm is supported therein, or to move arm support 40 to the non-use position. When in the non-use position, the operator's arm is not supported by arm support 40 during operation of lawn edger 10. Rather, the operator's arm may be spaced apart from arm support 40 and support shaft 20, or may be supported directly by upper portion 26 of support shaft 20 defining the arm support surface.

Arm support 40 is shown supporting the operator's forearm, however, arm support 40 may support any portion of the operator's arm. As further detailed herein, in certain illustrative embodiments arm support 40 may be removed from or rotated about support shaft 20 to a non-use position. Illustratively, arm support 40 includes a cuff having arcuate portions or tabs 43, 44 for supporting the forearm of the operator. In the illustrative embodiment, tabs 43, 44 are comprised of coated, shape-memory metal, however, tabs 43, 44 may be comprised of various metals, polymers, or fabrics. Tabs 33, 34 may be configured to deform to a particular shape. Moreover, tabs 43, 44 of arm support 40 may be pushed together or pulled apart to adjust the size of arm support 40 to the size and shape of the operator's arm. For example, tabs 43, 44 may be arranged in a C-shape, a U-shape, or a J-shape, or have other ergonomic configurations. Alternative embodiments of arm support 40 may include a hook, straps, a support board, elastic bands, or any device capable of supporting the operator's forearm during operation of lawn edger 10. By supporting the operator's forearm, arm support 40 may alleviate pressure on the operator's neck and shoulders while guiding lawn edger 10. Further, arm support 40 assists in allowing the operator to stand in an upright position when using lawn edger 10.

Arm support 40 is pivotably coupled to an arm support mount 42. Arm support mount 42 is illustratively coupled to inner tube 31 of adjustment member 30. As such, when arm support mount 42 is coupled to adjustment member 30, arm support 40 is configured to axially extend in a rearward direction and axially retract in a forward direction along longitudinal axis 21 concurrently with adjustment member 30. Arm support mount 42 illustratively supports arm support 40 for pivoting movement in directions 102, 102′ via a pivot pin 46. As such, pivot pin 46 enables arm support 40 to rotate approximately 180° about the axis transverse to longitudinal axis 21 between the raised position (FIG. 5) and the lowered position (FIG. 6). Alternatively, arm support mount 42 may be configured to support the movement of arm support 40 in directions 104, 104′. In addition to being pivotably coupled to arm support mount 42, arm support 40 may cooperate with a resistance mechanism, illustratively a friction lock, to hold arm support 40 in a desired angular position. In addition to a resistance mechanism, other conventional locking or latching mechanisms may be used to hold arm support 40 in a particular position relative to arm support mount 42 (e.g., thumb screws or detent pins).

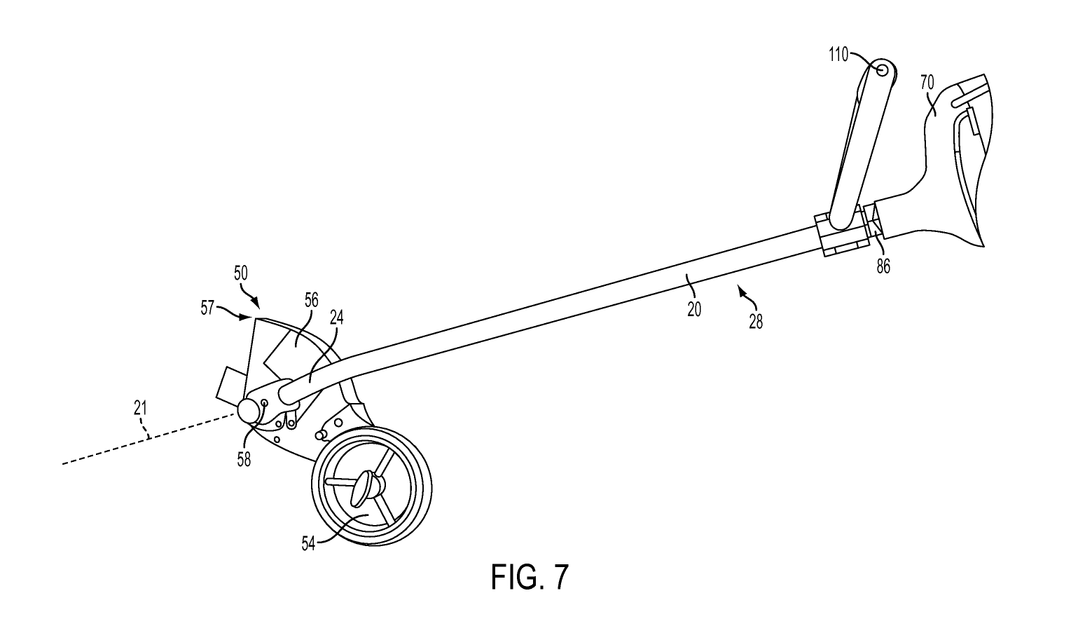

Referring to FIGS. 2 and 7, lower portion 28 of support shaft 20 is coupled to engine 70 and driven member 50. Lower portion 28 of support shaft 20 may have an axial, or length, adjustment member similar to adjustment member 30. Driven member 50 may be coupled to lower end 24 of support shaft 20 using conventional couplers, such as clamps, bolts, rivets, screws, welds, or adhesive. Driven member 50 includes cutting blade 52 which rotates against the ground to define the perimeter of the grass surface. Cutting blade 52 may be comprised of metal or other rigid material (e.g., hardened steel). Illustratively, a rotatable guide wheel 54 cooperates with driven member 50 to support lower end 24 of support shaft 20 and assist the operator when guiding lawn edger 10. Guide wheel 54 rotates along the ground and may be positioned rearward of cutting blade 52. A cutting shield or housing 56 may be provided to protect the operator from rocks, twigs, or other debris that may be caught in cutting blade 52 during operation and propelled rearwardly in the direction of the operator. Cutting shield 56 may also provide a guide edge 57 to guide the operator's path while using lawn edger 10. Driven member 50 illustratively further includes a gear box 58, operably coupled to cutting shield 56 and cutting blade 52, to transmit torque from drive shaft 18 to cutting blade 52. As such, drive shaft 18 is mechanically coupled to engine 70 and gear box 58 in order to drive cutting blade 52 during operation of lawn edger 10. Cutting blade 52, guide wheel 54, cutting shield 56, and gear box 58 may be of conventional design of the type used in the lawn care industry.

Referring to FIGS. 1, 2, and 8, engine 70 is supported on middle portion of support shaft 20 between upper end 22 and lower end 24. Specifically, engine 70 is mid-mounted on support shaft 20 intermediate upper portion 26 and lower portion 28 of support shaft 20. By mounting engine 70 away from upper end 22, noise produced by engine 70 is further away from the operator's ear. Moreover, because engine 70 is mid-mounted on support shaft 20, arm support 40 may be coupled to upper end 22 of support shaft 20.

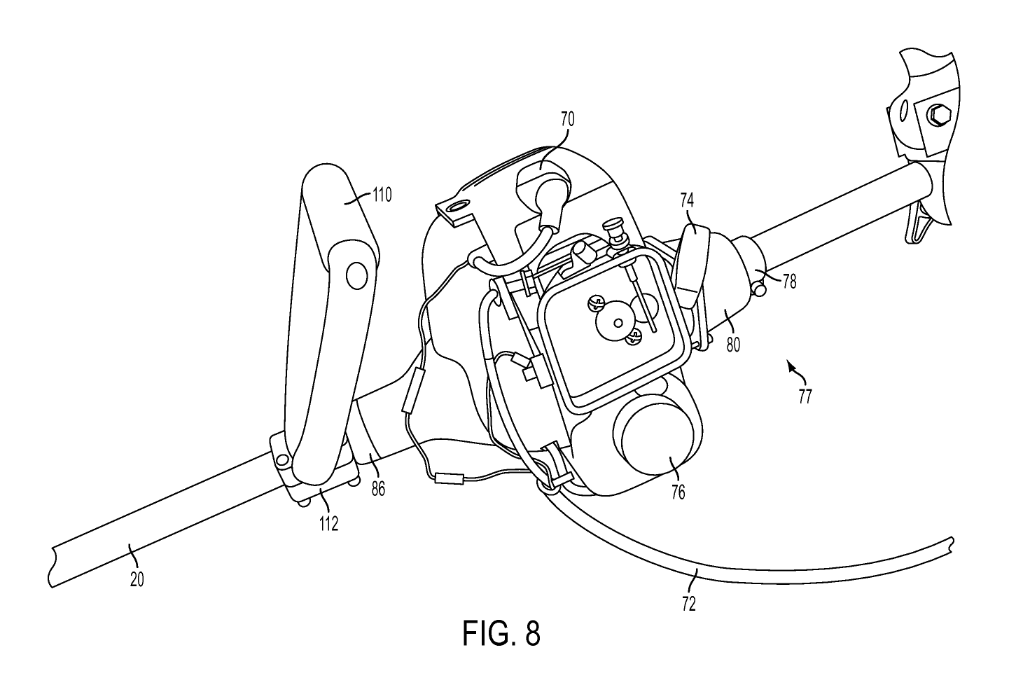

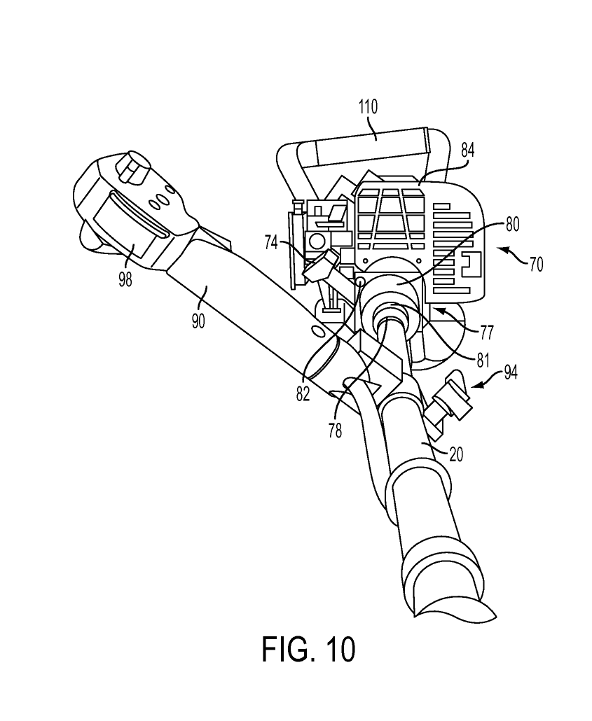

With reference to FIGS. 8 and 10, engine 70 is coupled to upper portion 26 of support shaft 20 by an upper coupler 77, including a clamp 78, a connector housing 80, and a plurality of fasteners 82. Clamp 78 is secured to upper portion 26 of support shaft 20 rearward of engine 70 and is illustratively comprised of a band clamp formed of aluminum. Connector housing 80 securely receives clamp 78 and abuts a pull start 74 of engine 70. In an alternative embodiment, pull start 74 may be formed integrally with connector housing 80. Connector housing 80 may be comprised of a rigid material, such as steel, and receives a resilient adapter 81. Adapter 81 secures clamp 78 within housing 80 and is illustratively formed of a rubber material to minimize transferring vibrational energy from engine 70 to support shaft 20. Connector housing 80 is secured to engine 70 using a plurality of couplers 82, which may be conventional fasteners, such as bolts or screws. Upper coupler 77 provides a coupling arrangement allowing for the in-line positioning of upper portion 26 and lower portion 28 of support shaft 20. In other words, upper coupler 77 facilitates the alignment of upper portion 26 with lower portion 28 of support shaft 20 to more evenly distribute the weight of lawn edger 10 during operation.

Engine 70 is coupled to lower portion 28 of support shaft 20 with a lower coupler 86, illustratively a conventional fastener (e.g., a band clamp). Additionally, engine 70 may be welded or bolted to lower portion 28. Alternatively, engine 70 may include a bell housing welded, bolted, or coupled with a band clamp to lower portion 28.

Illustratively, engine 70 is a gas engine, having pull start 74 and a fuel tank 76. Alternatively, engine 70 may be an electric engine or any other standard engine used for powered lawn tools. The inner diameter of lower portion 28 of support shaft 20 illustratively forms a conduit in order to operably couple engine 70 to driven member 50 through drive shaft 18. Engine 70 rotates drive shaft 18 by an internal motor and clutch (not shown) and drive shaft 18 simultaneously rotates cutting blade 52 through gear box 58. Drive shaft 18 may be flexible to accommodate varying alignments of engine 70 and cutting blade 52. The throttle of engine 70 is mechanically coupled with a throttle trigger 96 of control grip 90 by a throttle cable 72. Illustratively, a flexible, protective sheath is provided around throttle cable 72.

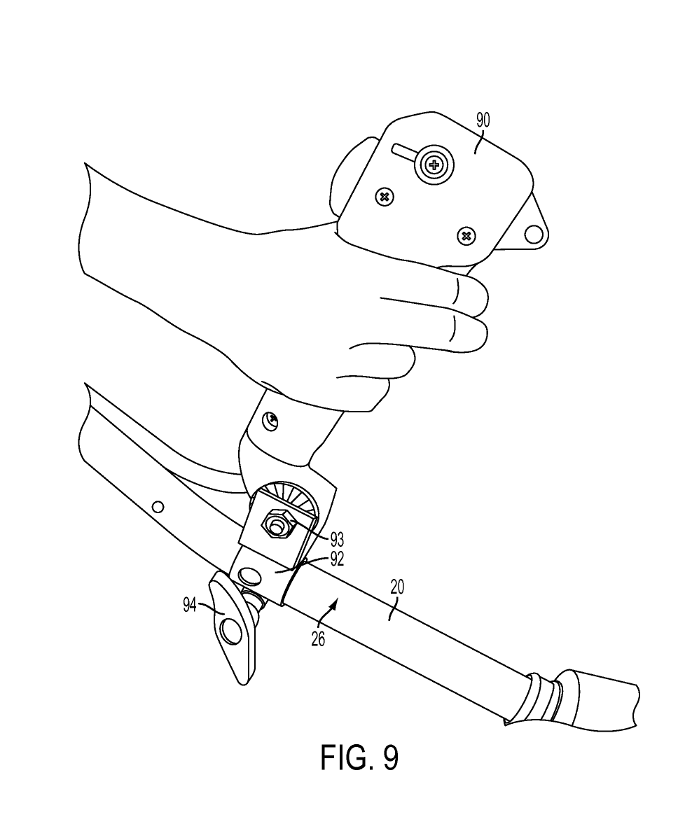

Referring to FIGS. 2, 9 and 10, lawn edger 10 further includes control grip 90 supporting user input 95. Control grip 90 is supported along upper portion 26 of support shaft 20 and is adjacent to arm support 40. More particularly, control grip 90 is supported intermediate arm support 40 and engine 70. The operator may use lawn edger 10 with only one arm because when the operator's arm is supported by arm support 40, control grip 90 is accessible to the operator. In order to accommodate different operators, both control grip 90 and arm support 40 are independently adjustable. Specifically, the absolute positions of control grip 90 and arm support 40 are adjustable relative to driven member 50. Additionally, control grip 90 is adjustable relative to arm support 40 and arm support 40 is likewise adjustable relative to control grip 90. In this way, lawn edger 10 provides many combinations of adjustable configurations for ergonomics and to accommodate the preferences and comfort of the operator.

Control grip 90 is operably coupled to engine 70 by throttle cable 72 in order to adjust the conditions of engine 70 and, thereby, adjust the conditions of driven member 50. Illustratively, control grip 90 is a pistol grip supporting user input 95. User input 95 includes the throttle trigger 96, a power switch 98, and a throttle lever 100. Power switch 98 is used to activate and deactivate engine 70 and may comprise a slide switch movable by an operator's thumb while gripping the control grip 90. For example, an “on” position of power switch 98 allows for normal operation of engine 70, whereas an “off” position of power switch 98 deactivates engine 70. Throttle trigger 96 allows the operator to adjust the speed of engine 70, thereby also adjusting the speed of cutting blade 52, by pressing or releasing throttle trigger 96. Throttle trigger 96 is illustratively operated by the fingers of an operator gripping control grip 90. Throttle lever 100 locks, or holds, throttle trigger 96 in position for a desired engine speed and may comprise a pivotable switch movable by an operator's thumb while gripping control grip 90. User input 95 may be any device capable of adjusting the speed and power of engine 70, such as a joy stick, touch screen monitor, digital keypad, or control knob.

Control grip 90 illustratively is mounted to support shaft 20 with a bracket 92 and a fastener 94. Control grip 90 may be axially and rotatably adjustable along upper portion 26 of support shaft 20. Bracket 92 extends around support shaft 20 and is tightened against support shaft 20 using fastener 94. To adjust the position or location of control grip 90, the operator loosens fastener 94 from bracket 92. In this way, bracket 92 is then loosely coupled to support shaft 20 allowing the operator to adjust the position of control grip 90 either axially along longitudinal axis 21 or rotatably about longitudinal axis 21. Control grip 90 is coupled to bracket 92 about a pivot pin 93. Pivot pin 93 allows control grip 90 to pivot on bracket 92. Control grip 90 pivots along an axis transverse to longitudinal axis 21 of support shaft 20 in order for the operator to tilt control grip 90 in a plurality of positions. Control grip 90 may pivot towards or away from arm support 40, depending on the operator's preference. Pivot pin 93 may cooperate with a conventional spring, screw, and/or bushing. In certain illustrative embodiments, a resistance mechanism or detent device may be provided to secure control grip 90 in a desired angular position about pivot pin 93.

By using bracket 92 with fastener 94 and pivot pin 93, control grip 90 has three degrees of freedom relative to support shaft 20. Specifically, by loosening fastener 94 from bracket 92, control grip 90 may move axially along support shaft 20 to define a first degree of freedom. Also, by loosening fastener 94 from bracket 92, control grip 90 also may rotate about longitudinal axis 21 of support shaft 20 to define a second degree of freedom. Additionally, control grip 90 may pivot on pivot pin 93 along the axis transverse to longitudinal axis 21 of support shaft 20 to define a third degree of freedom. In this way, control grip 90 is adjustable to accommodate different operators.

Referring now to FIGS. 1 and 8, guide handle 110 is coupled to support shaft 20 with conventional couplers 112 (e.g., screws or bolts). Guide handle 110 may be any conventional handle (e.g., T-handle) and the size of guide handle 110 may be adjusted to accommodate different operators. By providing guide handle 110 on lawn edger 10, the operator can use guide handle 110 for precision control of cutting blade 52 when turning or maneuvering lawn edger 10. When using guide handle 110 to turn lawn edger 10, the operator can alleviate pressure and strain on neck and shoulder muscles and walk in an upright position. However, when using lawn edger 10 in a straight line, guide handle 110 is not required to successfully operate lawn edger 10.

Illustratively, guide handle 110 is positioned forward of engine 70 along lower portion 28 of support shaft 20, however, guide handle 110 may be positioned on upper portion 26 of support shaft 20 (i.e., rearward of engine 70) between control grip 90 and engine 70. Alternatively, guide handle 110 may be welded or coupled along the top surface 84 of the casing of engine 70. Guide handle 110 is coupled to support shaft 20 in a slightly angled configuration, rather than a vertical configuration. As shown in the illustrative embodiment, guide handle 110 is angled toward engine 70. However, guide handle 110 may be rotated 180°, and as such, may be angled away from engine 70. Additionally, guide handle 110 may be coupled to support shaft 20 with an adjustable clamp to provide for adjustment axially along longitudinal axis 21, rotationally about longitudinal axis 21, and rotationally about an axis transverse to longitudinal axis 21.

Although the invention has been described in detail with reference to certain preferred embodiments, variations and modifications exist within the spirit and scope of the invention as described and defined in the following claims.

1. A lawn edger including:
a support shaft including a lower end and an opposing upper end;
an arm support surface supported on the support shaft;
a cutting blade operably coupled to the lower end of the support shaft;
an engine supported on the support shaft between the upper end and the lower end, the engine being operably coupled to the cutting blade; and
a control grip supported on the support shaft between the arm support surface and the engine, the control grip operably coupled to the engine and including a user input to control operation of the engine.

2. The lawn edger of claim 1, further including a handle positioned proximate the engine and supported on the support shaft.

3. The lawn edger of claim 1, wherein the lower end of the support shaft further includes a rotatable guide wheel.

4. The lawn edger of claim 1, wherein the control grip has a first degree of freedom, a second degree of freedom, and a third degree of freedom, the first degree of freedom being axial movement along a longitudinal axis of the support shaft, the second degree of freedom being rotational movement about the longitudinal axis of the support shaft, and the third degree of freedom being pivotal movement about an axis transverse to the longitudinal axis of the support shaft.

5. The lawn edger of claim 4, wherein the user input of the control grip includes a power switch and a throttle trigger in communication with the engine.

6. The lawn edger of claim 5, further comprising a drive shaft providing communication between the engine and the cutting blade, and wherein the support shaft defines a conduit for receiving the drive shaft.

7. The lawn edger of claim 1, wherein the arm support surface is defined by the upper end of the support shaft.

8. The lawn edger of claim 1, wherein the arm support surface is defined by an arm support member operably coupled to the support shaft.

9. The lawn edger of claim 8, wherein the arm support member is adjustable between a plurality of positions.

10. The lawn edger of claim 9, wherein the arm support member is pivotably coupled to the support shaft.

11. The lawn edger of claim 9, wherein the arm support is axially adjustable along the support shaft.

12. A powered lawn tool including:
a support shaft having an upper end and a lower end;
a driven member operably coupled to the lower end of the support shaft;
an engine supported on the support shaft between the upper end and the lower end, the engine being operably coupled to the driven member;
a control grip supported on the support shaft intermediate the upper end of the support shaft and the engine, the control grip being operably coupled to the engine and including a user input to control operation of the engine; and
a guide handle supported on the support shaft and positioned intermediate the control grip and the driven member.

13. The powered lawn tool of claim 12, wherein the control grip has a first degree of freedom, a second degree of freedom, and a third degree of freedom, the first degree of freedom being axial movement along a longitudinal axis of the support shaft, the second degree of freedom being rotational movement about the longitudinal axis of the support shaft, and the third degree of freedom being pivotal movement about an axis transverse to the longitudinal axis of the support shaft.

14. The powered lawn tool of claim 12, further comprising an arm support surface.

15. The powered lawn tool of claim 14, wherein the arm support surface is defined by the upper end of the support shaft.

16. The powered lawn tool of claim 14, wherein the arm support surface is defined by an arm support member operably coupled to the support shaft.

17. The powered lawn tool of claim 16, wherein the arm support member is adjustable between a plurality of positions.

18. The powered lawn tool of claim 17, wherein the arm support member is pivotably coupled to the support shaft.

19. The powered lawn tool of claim 17, wherein the arm support member is axially adjustable along the support shaft.

20. A lawn edging device including:
a support shaft having an upper end and an opposing lower end;
an adjustable arm support operably coupled to the upper end of the support shaft and configured for pivotal and axial movement;
a cutting blade operably coupled to the lower end of the support shaft;
a guide wheel coupled to the lower end of the support shaft proximate the cutting blade;
an engine supported on the support shaft between the cutting blade and the arm support, the engine being operably coupled to the cutting blade to drive the cutting blade in rotation;
an adjustable control grip supported on the support shaft intermediate the arm support and the engine, the control grip being configured for at least axial movement along the support shaft, the control grip being operably coupled to the engine and including a user input to control operation of the engine; and
a guide handle supported on the support shaft and positioned intermediate the engine and the cutting blade.
